(19) United States
(12) Patent Application Publication
(10) Pub. No.: US 2023/0264440 A1
(43) Pub. Date: Aug. 24, 2023

(54) STIFFENED PART FORMED FROM A THERMOSET COMPOSITE MATERIAL WITH A BOXED STRUCTURE AND MANUFACTURING METHOD

(71) Applicant: ArianeGroup SAS, Les Mureaux (FR)

(72) Inventors: Frederick CAVALIERE, Montigny Le Bretonneux (FR); Remi CROSSONNEAU, Paris (FR); Francisque BICEP, Cergy (FR); Joseph THAY-NAM, Houilles (FR)

(21) Appl. No.: 18/005,235

(22) PCT Filed: Jul. 16, 2021
(86) PCT No.: PCT/FR2021/051340

§ 371 Date: Jan. 12, 2023

(30) Foreign Application Priority Data
Jul. 17, 2020 (FR) FR2007522

(51) Int. Cl. B29C 70/86; B29C 70/32; B29C 70/68; B29C 70/02; H01Q 15/14

(52) U.S. Cl. CPC B29C 70/86; B29C 70/32; B29C 70/682; B29C 70/026; H01Q 15/142; B29L 2031/3456

(57) ABSTRACT

A stiffened part formed from at least two members of thermoset composite material including at least one body of a first structure and optionally a second structure. A manufacturing method includes: forming a fibre preform and impregnating each body of the first structure with thermosetting resin or forming a pre-impregnated fibre preform to obtain a body formed from uncured thermosetting composite material supported by a mandrel; optionally partially or fully polymerising at least one body supported by a mandrel; optionally, providing the second structure formed from uncured, partially uncured or fully uncured thermosetting composite material; optionally, depositing a layer of uncured thermosetting adhesive on an area where a fully cured member makes contact with another member of the part; joining the members, each member being juxtaposed with; or stacked upon, at least one other member; fully curing the assembly by heat treatment; removing the mandrel from each fully cured body.

### TECHNICAL FIELD

The invention relates to a stiffened part, wherein the stiffening mode is incorporated on at least one of the faces of the part made from thermoset composite material.

The invention can find an application for stiffening all parts made from thermoset composite material that are to have great dimensional stability under mechanical or thermal stresses and/or great rigidity. The invention thus applies to all technical fields that require stiff parts with complex forms; it may for example be a case of structural parts in the space field (for example satellite antenna reflector, satellite platform structure, dispenser (the structure that serves as a support for several satellites at the same time and for ejecting the satellites once in orbit in an order defined in advance), composite interstage structures, composite tanks, etc.) or aeronautical field (for example fuselage panels, wing panels, landing train flaps, access hatches, etc.) and can apply to the road, air, rail and maritime transport fields.

### PRIOR ART

Some parts require being stiffened. To illustrate the problem that is posed during the production of such parts, we shall describe the particular case of producing a part of the satellite antenna reflector type.

Currently, satellite antenna reflectors include a shell made from composite material that is assembled, after polymerisation, on a rigid rear structure. The shell has a complex double-curvature form; the rear structure, for its part, is composed of an assembly of tubes, of sleeves (allowing a join between the tubes) and of connection means of the bracket type (allowing a join between the rear structure and the satellite).

The rigid rear structure is assembled with the shell by means of connecting means of the angle iron type made from composite material having an L shape. The rear structure has a form different from the shell and is therefore not directly in contact with the shell during the assembly operation. One end of the angle iron is adhesively bonded to the rear structure and the other end is adhesively bonded to the shell. The angle and the width of the angle irons must be selected so as to allow good contact with the rear face of the shell (double curvature). Each connecting piece of the angle iron type must therefore be adapted, in particular to the curvature of the interface with the shell, which involves having available a large number of different connecting parts and a great deal of time for selecting the suitable connecting part.

Furthermore, all the adhesive bondings are implemented manually, using a paste adhesive, at ambient temperature (what is commonly called a cold bonding is implemented).

Finally, this stiffening and assembly method is particularly complex and time consuming, since it requires manufacturing numerous elements (tubes, sleeves, very many types of angle iron) and requires numerous meticulous operations of assembly by manual bonding at ambient temperature (assembly of the tubes/sleeves for producing the rear structure, and assembly of the shell/structure by means of angle irons), which has an impact on the cost of the stiffened structural parts thus obtained.

There is therefore a need for simplifying the operations of stiffening the shell and assembling the various elements, while keeping great reliability of the bonded connections.

This problem has been described in the particular case of satellite antenna reflectors, but is posed in a general manner for any structural part that has to be stiffened while being assembled with a set of stiffeners and having a variable bonding interface (because of a bonding interface with variable curvature, usually double curvature, and which may be different according to the assembly positions).

The objective of the invention is to propose a stiffening method that makes it possible to adapt easily to specific complex forms of structural parts to be stiffened, while reducing the manufacturing costs by drastically reducing the number of elements necessary for stiffening a structural part and reducing the various operations of bonding these elements on the part.

### DISCLOSURE OF THE INVENTION

For this purpose, the invention proposes a stiffened part comprising at least one first structure made from thermoset composite material, said first structure including at least one hollow longitudinal body having at least one open end.

The first structure is a box structure formed by one or more hollow bodies. Each hollow body may be a tubular component with a circular, rectangular or triangular cross section, or any other form.

Some preferred but non-limitative aspects of the stiffened part are as follows:
the first structure comprises at least two bodies, said bodies being juxtaposed and/or stacked, the contact between two adjacent bodies taking place through their lateral wall;
the first structure includes a first row of juxtaposed bodies and a second row of juxtaposed bodies, the first and second rows being stacked with an offset between the bodies in the first row and the bodies in the second row;
the first structure by itself alone forms the stiffened part;
the stiffened part furthermore comprises a second structure made from thermoset composite material, distinct from the first structure, the first structure being at least partly incorporated in the second structure and/or juxtaposed on a surface of the second structure; the second structure may be of the monolithic type (for example a monolithic plate) or of the sandwich type with an alveolar mandrel of the honeycomb or foam type with closed or open pores, and exterior skins disposed on either side of the mandrel;
the part may be a satellite antenna reflector.

The invention also relates to a method for manufacturing a stiffened part as described above, the stiffened part being formed by at least two elements made from thermoset composite material, including at least a body of the first structure and the optional second structure, the method comprising the following successive steps:
for each body of the first structure, either producing a fibrous preform of the body by draping a fabric around a mandrel and impregnating the fibrous preform with a thermosetting resin, or producing a pre-impregnated fibrous preform by draping a fabric pre-impregnated with a thermosetting resin around a mandrel, by means of which a body made from non-polymerised thermosetting composite material supported by a mandrel is obtained;
optional partial or complete polymerisation of at least one body made from thermosetting composite material supported by a mandrel;
if the stiffened part includes a second structure, supplying the second structure, the second structure being made from non-polymerised, partially polymerised or completely polymerised thermosetting composite material;
if there is at least one element made from completely polymerised thermosetting composite material, depositing a layer of non-polymerised thermosetting adhesive on a zone of contact of said element with another element of the part;
assembling elements forming the part, each element being juxtaposed with, or stacked on, at least one other element;
completely polymerising the assembly by heat treatment;
removing the mandrel from each completely polymerised body.

According to a variant, the method furthermore comprises, before the assembly step, a deposition of an adhesive film between two non-polymerised and/or partially polymerised elements. This makes it possible to hold these two elements together during assembly; this can also make it possible to improve the mechanical strength of the assembly interface, once the two elements are completely polymerised.

Preferably, the optional step of complete polymerisation of at least one body made from thermosetting composite material supported by a mandrel is not implemented. This is because it is preferable for the body or bodies of the first structure to be completely polymerised when the assembly with the second structure takes place, which makes it possible to correctly position the bodies following the out-of-plane curvatures and the in-plane curvatures at the assembly interfaces with the second structure.

The polymerisation of two adjacent elements will be done by co-curing or by

co-bonding depending on whether the two elements will or will not be in a completely polymerised state before assembly.

According to one embodiment, among the elements forming the part, there are furthermore at least one sheet or a fabric pre-impregnated with thermosetting resin or which is impregnated subsequently with thermosetting resin, this sheet or this fabric being applied, during the assembly step, on at least one body, preferably on several stacked and/or juxtaposed bodies, and/or on the optional second structure.

According to another embodiment, for at least one body, the mandrel is a group of at least two mandrels with smaller cross sections, either stacked, or laterally juxtaposed.

Advantageously, each mandrel is made from flexible elastomer. The mandrel may be hollow or solid; preferably a solid mandrel is selected.

According to a variant, at least one mandrel has a polygonal cross section, for example of the triangular or parallelepipedal type. The cross section may be constant or variable.

The mandrels may have a constant cross section or a variable cross section that increases from one end of the mandrel to the other.

The invention has many advantages. The body or bodies of the first structure make it possible to produce a box assembly that can be adapted easily to specific complex forms in plane or out of plane, making it possible to adapt to the surface of a part to be stiffened (the part may for example have a double-curvature surface). In other words, the hollow body or bodies forming the first structure are capable of following the curvatures in plane and out of plane at the assembly interfaces with the second structure. The hollow body or bodies may be rectilinear or adopt any necessary curvature in the plane of assembly with the second structure.

This also makes it possible to reduce the manufacturing costs (in particular by a drastic reduction in the number of elements necessary for stiffening, a simplification of the positioning thereof on the part to be stiffened and a reduction in the various operations of bonding the stiffening structure compared with the prior art).

Finally, the invention makes it possible to ensure good mechanical strength and great reliability of the bonded connections.

### BRIEF DESCRIPTION OF THE DRAWINGS

The present invention will be best understood from the reading of the description that follows, given purely by way of indication and in no way limitatively, referring to the accompanying drawings, on which:

FIG. 1 shows an example according to the invention of a body obtained by draping a pre-impregnated sheet or fabric around a mandrel with a triangular cross section, the body having two open ends;

FIG. 2 shows another example according to the invention of a body obtained by draping a pre-impregnated sheet or fabric around a mandrel with a triangular cross section, the body having two open ends;

FIG. 3 shows another example according to the invention of a body obtained by draping a pre-impregnated sheet or fabric around a mandrel with a rectangular cross section, the body having a single open end;

FIG. 4 shows another example according to the invention of a body obtained by draping a pre-impregnated sheet or fabric around a mandrel with a variable cross section, the body having two open ends;

FIG. 5a shows, in a view in cross section, an example of draping a fabric or a sheet around a mandrel with a rectangular cross section;

FIG. 5b shows, in a view in cross section, another example of draping a fabric or sheet around a mandrel with a rectangular cross section;

FIG. 5c shows, in a view in cross section, another example of draping a fabric or a sheet around a mandrel with a rectangular cross section;

FIG. 5d shows, in a view in cross section, an example of draping several fabrics or sheets around a mandrel with a rectangular cross section;

FIG. 5e shows, in a view in cross section, another example of draping several fabrics or sheets around a mandrel with a rectangular cross section;

FIG. 5f shows, in a view in cross section, another example of draping a fabric or a sheet around a mandrel with a rectangular cross section;

FIG. 6 shows, in a perspective view, a body formed by draping a fabric around a mandrel formed by a plurality of mandrels with smaller cross sections that are stacked and/or juxtaposed longitudinally;

FIG. 7 shows a view in cross section in the plane A of FIG. 6;

FIG. 8 shows, in a view in cross section, an example of production of a stiffened part according to the invention;

FIG. 9 shows, in a view in cross section, another example of production of a stiffened part according to the invention;

FIG. 10 shows, in a view in cross section, another example of production of a stiffened part according to the invention;

FIG. 11 shows, in a view in cross section, another example of production of a stiffened part according to the invention;

FIG. 12 shows, in a view in cross section, another example of production of a stiffened part according to the invention;

FIG. 13 shows, in a perspective view, an example of placing a body (supported by a mandrel) of a surface of a second structure (for example a part to be stiffened), the body being placed in a radial direction of the second structure;

FIG. 14 shows, in a perspective view, an example of placing a body (supported by several mandrels) on a surface of a second structure (for example a part to be stiffened), the body being placed in a radial direction of the second structure and projecting beyond the second structure, the contact surface between the first structure and the second structure not being over the whole of the length of the body;

FIG. 15 shows, in a perspective view, another example of placing a body (supported by several mandrels) on a surface of a second structure (for example a part to be stiffened), the body being placed in a radial direction of the second structure and projecting beyond the second structure, the contact surface between the first structure and the second structure not being over the whole of the length of the body and a separation being left between the body and the second structure;

FIG. 16 shows, in a perspective view, an example of placing a body (supported by a mandrel) on a surface of a second structure (for example a part to be stiffened), the body being placed in a circumferential direction of the second structure;

FIG. 17 shows, in a perspective view, an example of a stiffened part obtained by placing, on a surface of a second structure (here the part to be stiffened), a first structure formed by a first body disposed in a first radial direction of the second structure, and a second and third body disposed on either side of the first body in a second radial direction of the second structure, which may be perpendicular to the first direction;

FIG. 18 shows, in a perspective view, another example of a stiffened part obtained by placing, on a surface of a second structure (here the part to be stiffened), a first structure formed by a row of juxtaposed bodies disposed in radial directions of the second structure;

FIG. 19 shows, in a perspective view, another example of a stiffened part obtained by placing a first structure formed by a plurality of bodies on a surface of a second structure (here the part to be stiffened), some bodies being positioned in radial directions of the second structure and others in circumferential directions of the second structure, the bodies being joined to one another in contact zones;

FIG. 20 shows, in a perspective view, another example of a stiffened part, comprising a first structure formed by a first body disposed in a radial direction of a second structure (here the part to be stiffened) and a second body disposed straddling the first body and the second structure, in a circumferential direction of the second structure;

FIG. 21 shows, in a perspective view, another example of a stiffened part, produced solely from bodies assembled to one another and forming the first structure;

FIG. 22 shows, in a plan view, an example of six bodies disposed radially and at equal distances from one another on the surface of a second structure (the part to be stiffened);

FIG. 23 shows, in a plan view, an example of three bodies disposed on the surface of a second structure (the part to be stiffened), each body having an end that projects beyond the second structure and the other end joining a lateral wall of one of the other bodies, the junction of the three bodies forming a triangle at the centre of the second structure;

FIG. 24 shows, in a plan view, another example of four bodies disposed on the surface of a second structure (the part to be stiffened), each body having an end that projects beyond the second structure and the other end joining a lateral wall of one of the other bodies, the junction of the four bodies forming a square at the centre of the second structure;

FIG. 25 shows, in a plan view, another example of four bodies disposed on the surface of a second structure (the part to be stiffened), each body having an end that comes to a location at the periphery of the second structure and the other end that comes to another location, diametrically opposite, at the periphery of the second structure, each body overlapping one of the three other bodies and being overlapped by another one of the other three bodies;

FIG. 26 shows, in a plan view, another example of four bodies disposed on the surface of a second structure (the part to be stiffened), one end of each body running along the periphery of the second structure and the other end joining a lateral wall of one of the other bodies in proximity to the centre of the second structure, the junction of the four bodies forming a circle at the centre of the second structure.

### DETAILED DISCLOSURE OF PARTICULAR EMBODIMENTS

The stiffened part according to the invention includes a first structure 6 and an optional second structure 7, the first and second structures being made from thermoset composite material, and the first structure comprising at least one hollow longitudinal body 2 having at least one open end 3.

The thermoset composite material is a composite material of the fibrous reinforcement type impregnated by a thermosetting matrix that is thermoset by heat treatment. This is in particular what will make it possible to assemble the various elements forming the part by co-curing or by co-bonding, as we shall see below.

The fibrous reinforcement may be made from carbon and/or glass fibres and/or Kevlar™ fibres; it may also be a combination of several types of fibre, for example a mixture of glass/carbon fibres, or carbon/Kevlar™ fibres.

The matrix is a resin binder that impregnates the reinforcement and solidifies when it is polymerised. In the invention, the matrix is a thermosetting resin. The monomer based on epoxy resin may for example be of the DGEBA type (bisphenol A diglycidyl ether), TGPAP (triglycidyl p-aminophenol) or TGMDA (tetraglycidyl methylene dianiline). The hardener may be of the amine type, for example DDS (diaminodiphenyl sulfone).

The thermosetting resins used and described in this document completely polymerise at a temperature generally between 120° C. and 220° C. over a period of two hours at polymerisation temperature. More precisely, the resins most used in space and aeronautics are so-called 180° C. class resins, for which complete polymerisation is achieved after 2 hours at 180° C.

For the fibrous reinforcement, it is possible to use fabrics or sheets and stack them to form layers. It is possible to use a pre-impregnated fibrous reinforcement of thermosetting resin (also called “prepreg”), or to impregnate a fibrous reinforcement with the resin after shaping of this fibrous reinforcement. The fibrous reinforcement impregnated with resin may optionally be compacted before undergoing polymerisation.

In general terms, in the context of the present invention, assembling two elements (whether it be a case for example of assembling two bodies 2 of the first structure 6 or assembling the first structure 6 with the second structure 7) corresponds either to a bonding by co-curing, when the two elements to be assembled are non-polymerised or partially polymerised and are brought to a state of complete polymerisation in the same heating cycle, or to bonding by co-bonding when one of the two elements is already completely polymerised, with the need to implement a surface preparation of the polymerised element and to dispose at the interface of the two elements a layer of adhesive made from thermosetting resin, an adhesive preferentially in the form of a film. In other words, provided that an element is completely polymerised, it is necessary, for it to be assembled with another element, for a layer of adhesive to be deposited at the bonding interface of the two elements. A preparation of the bonding interface will generally be done by sanding and cleaning with a solvent, in order then to deposit a film of adhesive. In the case of bonding by co-bonding, there are two heating cycles, a first cycle during which one of the two elements is completely polymerised and a second cycle during which the second element, and the adhesive, are completely polymerised. Finally, whether by bonding by co-curing or by co-bonding, a bond is obtained between the two elements by hot bonding that has great reliability and very good mechanical strength.

We shall now describe in detail the method for producing a stiffened part according to the invention.

### Production of the Body or Bodies:

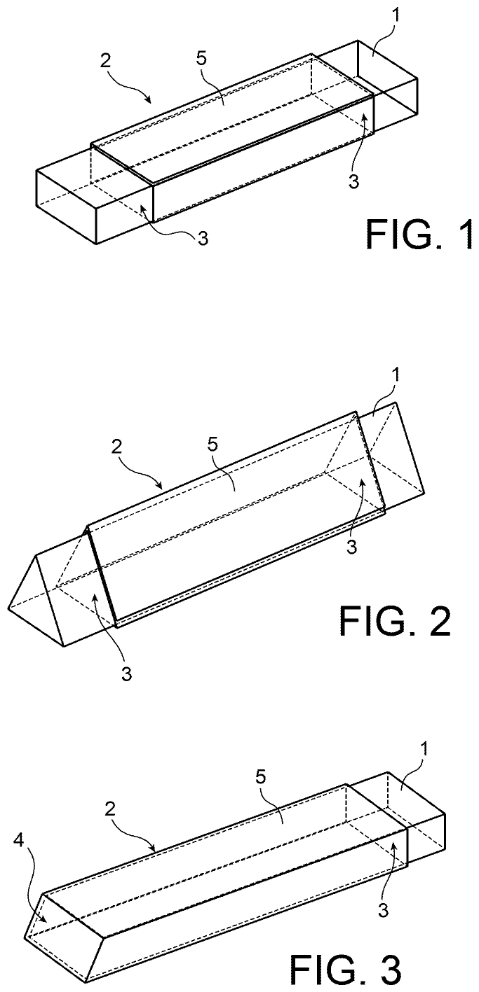

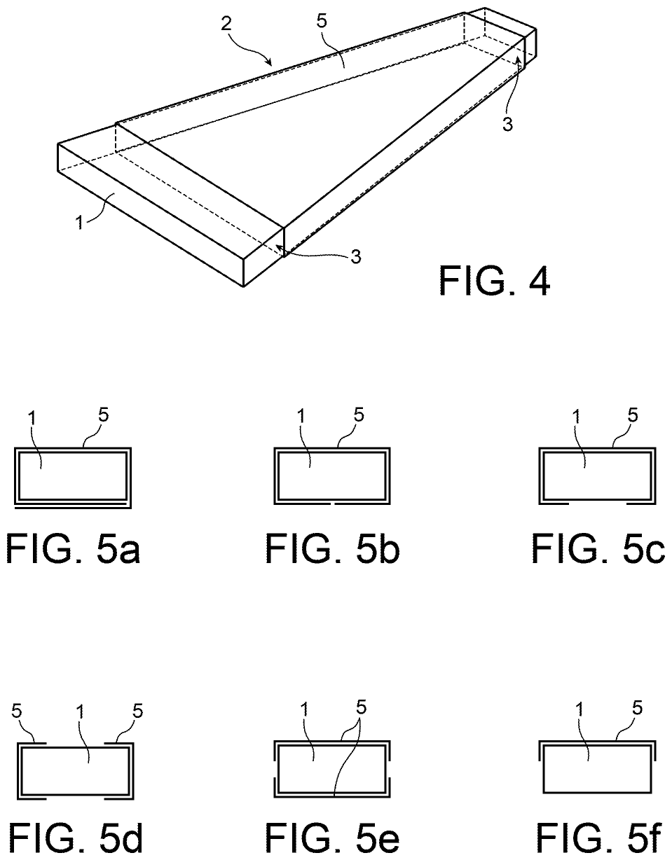

First, one or more hollow longitudinal bodies 2 are produced. To do this, a fabric or a sheet 5 is draped by winding around a mandrel 1 in order to form a preform. The fabric or sheet 5 may be pre-impregnated with thermosetting resin, or be dry and the fabric or sheet is impregnated with a thermosetting resin subsequently, for example by injecting or infusing the resin in the dry preform already shaped. The injection/infusion phase occurs when the preform is placed in a closed mould. This phase is followed by a polymerisation of the injected resin. As illustrated in FIGS. 1 and 2, the mandrel 1 may have a constant cross section, for example rectangular (FIG. 1) or triangular (FIG. 2) or a variable cross section (FIG. 4). If the cross section is variable, it must nevertheless allow an extraction of the mandrel out of the body once the resin is polymerised. In this case particular attention will be paid to the variation in cross section or the deformation of the mandrel allowing removal (extraction), from the open end 3, of the mandrel placed inside the body.

The body 2 must have at least one open end 3 (in FIG. 3, the body has a closed end 4); it may have two open ends 3 (FIGS. 1, 2, 4) in order to enable the mandrel to be taken out.

One or more layers of fabric or sheet 5 may be wound around one and the same mandrel 1. The winding of each layer may be done:
by overlapping (the fabric folds over itself) (FIG. 5a);
by contiguous joining (the fabric touches itself without overlapping) (FIG. 5b);
by non-contiguous joining (for example, partially tubular winding (FIG. 5c) or partial winding (FIG. 5f)).

It is also possible to use at least two layers, contiguous or not (FIGS. 5d and 5e), to form a body 2.

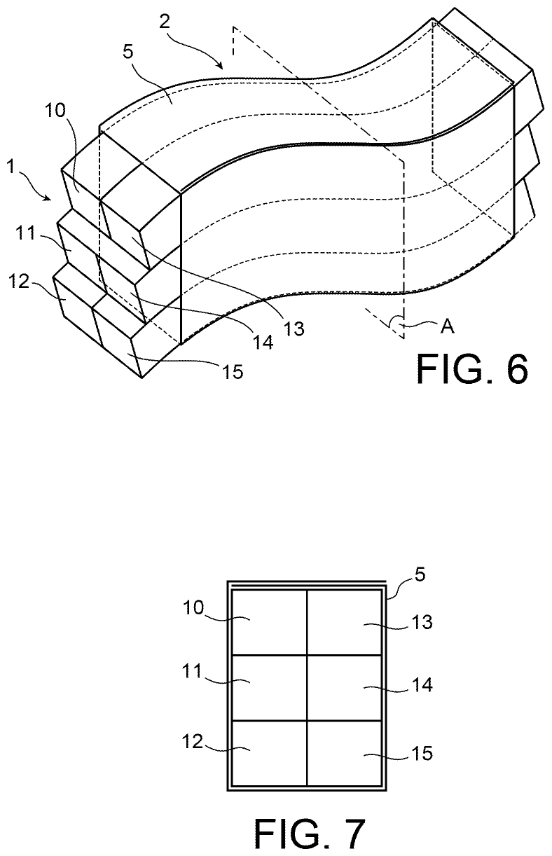

It is also possible to wind one (or more) layer(s) of fabric or sheet 5 around a mandrel 1 formed by a plurality of mandrels 10, 11, 12, 13, 14, 15 with smaller cross sections grouped together laterally, as illustrated in FIGS. 6 and 7. This may prove necessary when the form of the second structure 7, to which the body 2 must adapt, is very curved and/or the height of the body 2 is great. There also, the draping may be done over the entire periphery of the mandrel or only over a part (partial draping).

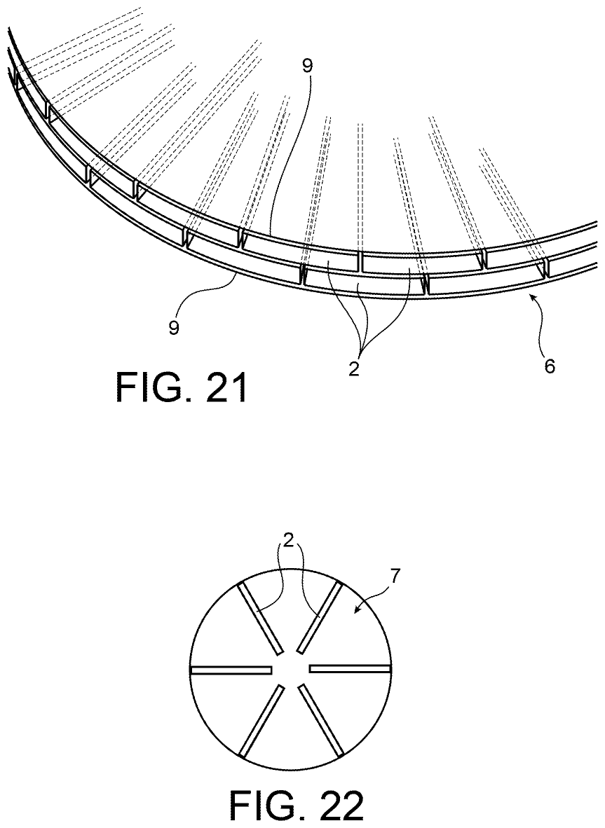

As already stated, the part to be stiffened includes a first structure 6, composed of one or more bodies 2, and an optional second structure 7. Given that the stiffened part necessarily includes two elements including a body, then, if the first structure 6 includes only one body 2, there will necessarily be a second structure 7. The stiffened part may include only a first structure 6, as illustrated in FIG. 21, but it generally includes a second structure 7, which is generally the part to be stiffened. This structure 7 may be a sandwich structure consisting of 2 skins and a core material of the alveolar type; generally it will be a case of an alveolar core in a honeycomb, but it may also be a core made from foam with closed or open pores. In the case of a satellite antenna reflector, the second structure 7 is the sandwich shell of the reflector that it is wished to stiffen.

According to a variant of the invention, it is possible to drape the fabrics or sheets 5 over the surface of the second structure 7 at the assembly interface between the second structure 7 and a body 2, then to place the mandrel 1, or several mandrels 1, on the fabrics or sheets, and finally to wind the fabrics or sheets around the mandrel or mandrels. This may be useful in the case where there will be many layers to wind around the mandrel or mandrels and/or when the form of the second structure is very curved.

Preferably, the mandrel is made from flexible elastomer so as to:
be able to easily adapt to the form of the second structure on which it is intended to be positioned;
be able to extract the mandrel easily from inside the body by constriction (elongation traction of the elastomer, accompanied by a reduction in the cross section during elongation).

Assembly of the body or bodies of the first structure and of the optional second structure:

The second structure 7 may be of the monolithic type or of the sandwich type. Preferentially, in the case of the application to the antenna reflector, the second structure is of the sandwich type.

According to one embodiment, the non-polymerised or partially polymerised body or bodies are placed on the non-polymerised or partially polymerised second structure 7 taking care to properly follow the form of the surface of the second structure and the defined location.

It is possible to use laser projection of the location of each body on the second structure to assist positioning and to improve the precision of the placing.

Intermediate compactings under negative pressure may be used as the bodies are deposited, in order to ensure better holding on the second structure 7 and better conformation of each body.

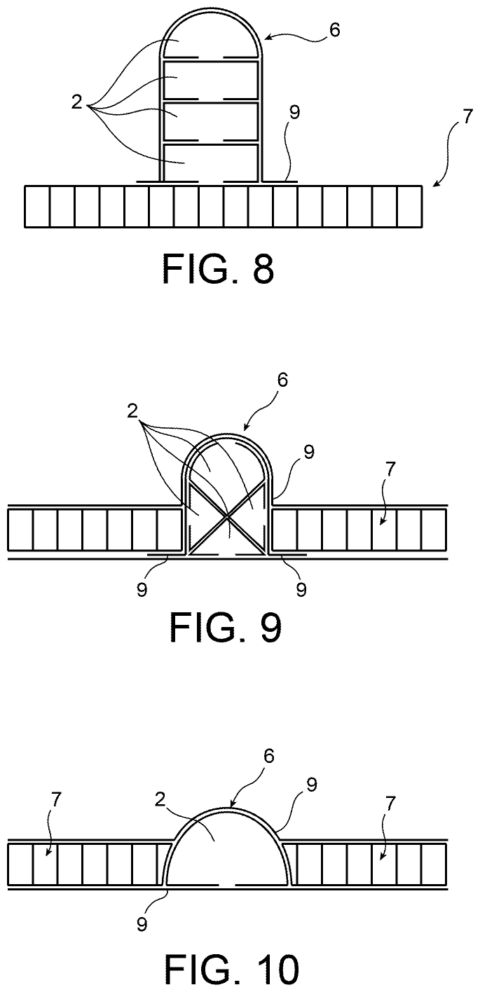

It is also possible to implement a deposition of additional plies 9 of fabrics or sheets pre-impregnated with thermosetting resin that cover one or more bodies, as well as a part of the surface of the second structure (as illustrated in particular in FIGS. 8, 9, 10, 11, 12, 19).

Once all the elements are positioned, polymerisation of the whole is implemented. Then assembly by co-curing will be obtained.

In a variant, the second structure 7 may be completely polymerised. In this case, it will be necessary, before placing the body or bodies 2 on the second structure 7, to prepare the surface of the second structure in the assembly zone (for example degreasing, sanding, cleaning), and then to deposit thereon a layer of thermosetting adhesive before draping the bodies 2. After polymerisation of the whole, in this way assembly by co-bonding is obtained.

In a variant, it is possible to implement the assembly of the bodies directly on the draping mould of the second structure. Next, partial polymerisation of the bodies (semi-curing) is implemented, they are separated from the mould and the assembly produced is stored without the mandrel being removed. During the partial polymerisation step, the degree of polymerisation, measured by differential scanning calorimetry (DSC) in accordance with ISO 11357-1: 2016, is between 10% and 75%, and preferentially between 15% and 40%. Subsequently, this assembly can be placed on the surface of the second structure to be stiffened, and complete polymerisation can be implemented. Assembly will be by co-curing if the second structure is non-polymerised or partially polymerised, or by co-bonding if the second structure is polymerised (in this case, it will be necessary first to deposit a layer of adhesive, as described previously).

In a variant, it is possible to produce the second structure 7 by implementing the draping of the second structure on a draping mould with pre-impregnated fabrics or sheets, and then the first structure, already formed, is assembled, forming a box assembly, on the non-polymerised second structure. If the first structure is partially polymerised, there is no need to implement a surface preparation at the bonding interface, nor a need for an adhesive film at the interface (assembly being assimilated to co-curing). On the other hand, if the first structure is completely polymerised, it is necessary to implement a preliminary surface treatment of the surface at the bonding location (degreasing, sanding, cleaning), and then adding an adhesive film (in order to obtain assembly by co-bonding).

In this variant, partial polymerisation of the first structure is preferred; thus, during the final polymerisation, the viscosity of the partially polymerised resin of the first structure will decrease (softening of the resin) and will allow, firstly, good conformation of the first structure to the surface of the second structure and, secondly, the creation of bonds between the polymer chains of the two resins (first and second structures).

In the case where the two structures 6 and 7 are partially polymerised, the behaviour of the resins of each structure will be similar during the final polymerisation. When the temperature rises, the viscosity of each resin will decrease, allowing good conformation of the structures at the location of the assembly interfaces, along with the creation of bonds between the polymer chains of the two resins.

It will also be possible to position an adhesive film at the interface between the two raw structures 6 and 7, between a raw structure and a partially polymerised structure, or between two partially polymerised structures 6 and 7 for reasons of maintenance in position during the draping and/or for reasons of mechanical strength of the bonded connection once completely polymerised.

The assembly configurations of the body or bodies are many.

The body 2 forming the first structure 6 can be assembled on the second structure (FIG. 8), both on and in the second structure (FIG. 12) or in the second structure (FIGS. 9, 10, 11). It is also possible for there not to be a second structure 7 and for the first structure 6 to form by itself alone the stiffened part (FIG. 21).

In FIG. 21, the first structure 6 includes a first row of juxtaposed bodies and a second row of juxtaposed bodies, the first and second rows being stacked and the bodies in the first row being offset with respect to the bodies in the second row. For example, as illustrated in FIG. 21, the first and second rows may be offset by an offset of a half width of a body. This FIG. 21 illustrates one of the many possible examples of a stiffened part. By changing the number of rows, forms of the bodies, and the position of the bodies in relation to each other, it is possible to obtain many configurations, not detailed in this description.

In FIGS. 8 to 12, the stiffened part includes a first structure 6 and a second structure 7.

In FIG. 8, the first structure 6 is a stack of four bodies 2; the first structure is assembled on the surface of the second structure 7 with a ply 9.

In FIG. 9, the first structure 6 is a group of four bodies 2, while in FIG. 10 the first structure 6 includes a single body 2.

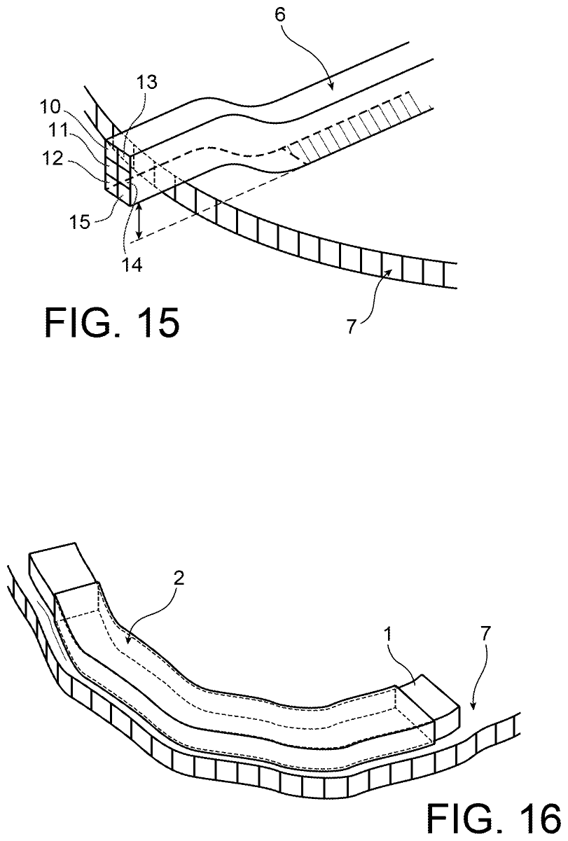

In FIGS. 9 and 10, the first structure 6 is partly incorporated in the second structure 7. For the body or bodies 2 that are in contact with the second structure 7, the contact may be a partial contact. In this, the body or bodies 2 may go beyond the surface of the second structure 7 (as illustrated for example in FIG. 14) or have locally a separation between the two surfaces so that they are no longer assembled (as illustrated for example in FIG. 15).

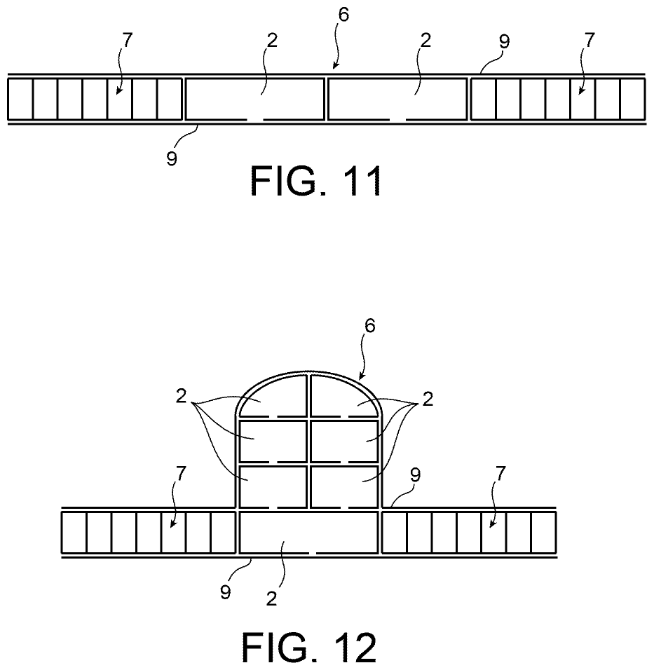

In FIG. 11, the first structure 6 includes two juxtaposed bodies 2 and is completely incorporated in the second structure 7.

It should be noted that, in FIGS. 8, 9, 11 and 12, the contact between the adjacent bodies takes place through their lateral wall.

In FIG. 12, the first structure 6 includes seven stacked juxtaposed bodies 2 and is partly incorporated in the second structure 7; here one of the seven bodies is completely integrated in the second structure 7 and the six other bodies are located above the surface of the second structure 7.

It should be noted that, among the bodies 2 forming the first structure, two or more adjacent bodies may not be in contact with each other, since a ply 9 may be disposed between two adjacent bodies.

When the stiffened part includes first and second structures, various assembly configurations are possible.

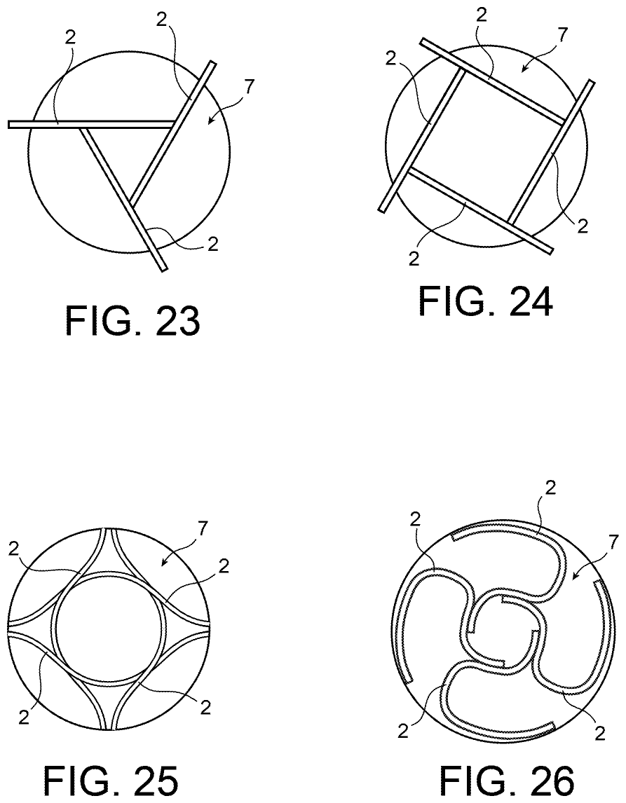

The body or bodies 2 of the first structure 6 may be arranged in any direction on the surface of the structure 7. The positioning of the body or bodies 2 on the surface of the structure 7 may be rectilinear (for example, FIGS. 22, 23, 24) or curved (for example FIGS. 25 and 26).

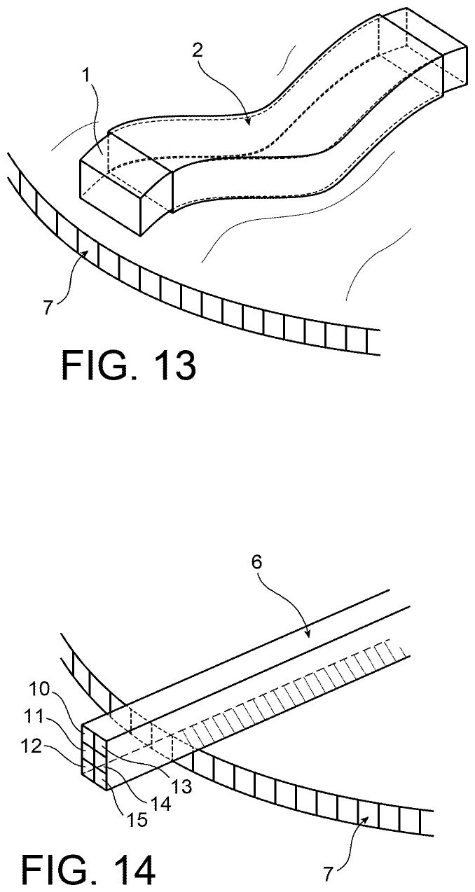

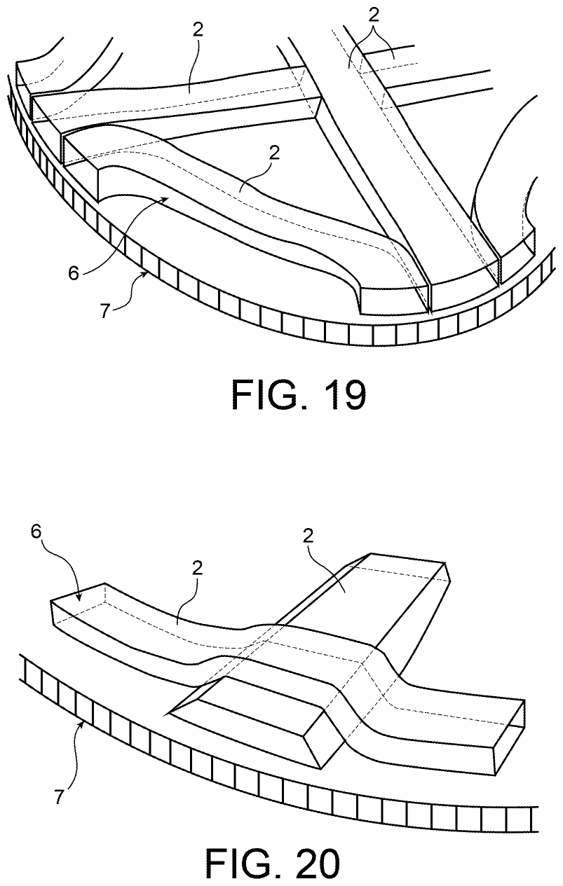

For example, the body or bodies 2 of the first structure 6 may be arranged on the surface of the second structure 7 in a radial direction of the second structure (FIG. 13), in a circumferential direction of the second structure (FIG. 16) or in a configuration combining radial and circumferential directions (FIG. 19).

The body or bodies 2 may project beyond the second structure 7, as illustrated for example in FIG. 14, where it can be seen that the contact surface between the body 2 of the first structure and the second structure is not over the whole of the length of the body. There may also be a separation between the body or bodies 2 and the surface of the second structure 7, as illustrated for example in FIG. 15.

Other configurations are illustrated in FIGS. 22 to 26, where the part to be stiffened (the second structure 7) is a plate with a circular periphery.

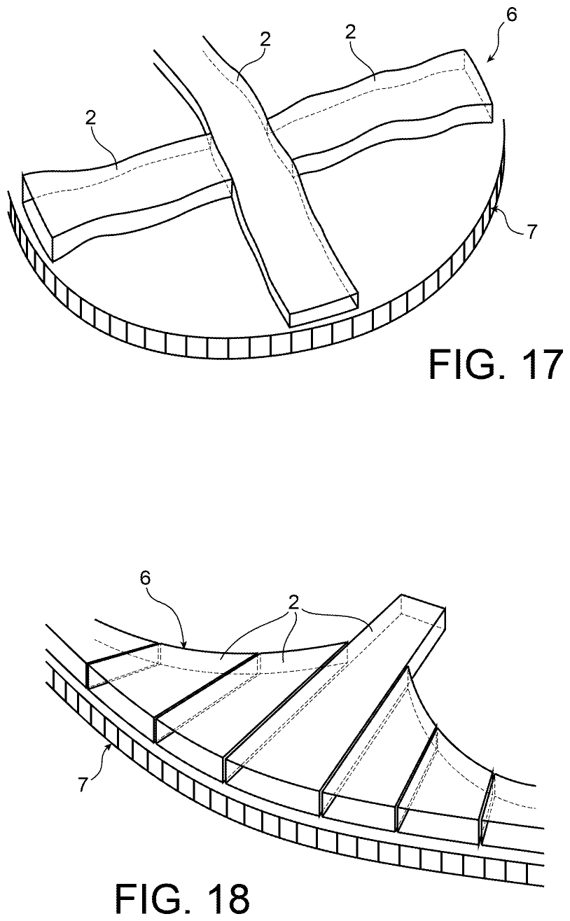

In FIG. 17, there is a configuration where the first structure 6 is in a cross shape, with a first long body 2 positioned in a first radial direction of the second structure 7 and two less long bodies, which are positioned on either side of the first body, in a radial direction of the second structure, perpendicular to the first direction. Here the two less long bodies preferably have an open end (for bringing out the mandrel) and a closed end, the lateral wall of the closed end allowing assembly with the lateral wall of the first body. In FIG. 17, unlike FIG. 16, the stiffened part is shown after extraction of the mandrels 1.

In FIG. 18, the first structure 6 includes a row of seven juxtaposed bodies 2 with different lengths; the contact between the adjacent bodies is made by their lateral wall.

It is also possible to have an overlap of the bodies 2, as shown in FIG. 20; here, one of the two bodies 2 is disposed in a radial direction of the second structure 7 and the other in a circumferential direction, the latter body being disposed both on the surface of the second structure and on a part of the first body and it conforms to the form of the surface of the second structure, as well as to that of the body that it overlaps.

A few plies 9 may cover the body or bodies 2 of the first structure 6 and/or of the second structure 7. For example, in FIG. 8, a few plies 9 cover the first structure, with a return over the surface of the second structure; a draping in the form of an omega (Ω) is obtained. In FIG. 9, a first draping covers the four bodies of the first structure, and a second and third draping cover respectively the top surface and the bottom surface of the second structure, as well as the first structure 6. In FIGS. 10 and 11, a first and a second draping cover respectively the top surface and the bottom surface of the second structure. In FIG. 12, a first and second ply 9 cover respectively the bottom and top surface of the second structure 7, as well as the body integrated in the second structure 7. A third ply 9 covers the surface of the structure 6 and a part of the top surface of the structure 7. In FIG. 21, a few plies 9 can be draped on the front and rear faces of the first structure 6, or between the rows of bodies 2, to finalise the draping.

What is claimed is:

1-11. (canceled)

12. A method for manufacturing a stiffened part, the stiffened part being formed by at least two elements made from thermoset composite material, including at least a body of a first structure and an optional second structure, the first structure including at least one hollow longitudinal body having at least one open end, the method comprising the following successive steps:
for each body of the first structure, either producing a fibrous preform of the body by draping a fabric around a mandrel and impregnating the fibrous preform with a thermosetting resin, or producing a pre-impregnated fibrous preform by draping a fabric pre-impregnated with a thermosetting resin around a mandrel, by means of which a body made from non-polymerised thermosetting composite material supported by a mandrel is obtained, wherein, for at least one body, the mandrel is a group of at least two mandrels with smaller cross sections, either stacked, or laterally juxtaposed;
optional partial or complete polymerisation of at least one body made from thermosetting composite material supported by a mandrel;
if the stiffened part includes a second structure, supplying the second structure, the second structure being made from non-polymerised, partially polymerised or completely polymerised thermosetting composite material;
if there is at least one element made from completely polymerised thermosetting composite material, depositing a layer of non-polymerised thermosetting adhesive on a zone of contact of said element with another element of the part;
assembling elements forming the part, each element being juxtaposed with, or stacked on, at least one other element;
completely polymerising the assembly by heat treatment;
removing the mandrel from each completely polymerised body.

13. The method according to claim 12, furthermore comprising, before the assembly step, a deposition of an adhesive film between two non-polymerised and/or partially polymerised elements.

14. The method according to claim 12, wherein, among the elements forming the part, there are furthermore at least one sheet or a fabric pre-impregnated with thermosetting resin or which is impregnated subsequently with thermosetting resin, this sheet or this fabric being applied, during the assembly step, on at least one body, preferably on several stacked and/or juxtaposed bodies, and/or on the optional second structure.

15. The method according to claim 12, wherein each mandrel is made from flexible elastomer.

16. The method according to claim 12, wherein the first structure comprises at least two bodies, said bodies being juxtaposed and/or stacked, the contact between two adjacent bodies taking place through their lateral wall.

17. The method according to claim 12, wherein the first structure includes a first row of juxtaposed bodies and a second row of juxtaposed bodies, the first and second rows being stacked with an offset between the bodies in the first row and the bodies in the second row.

18. The method according to claim 12, wherein the first structure by itself alone forms the stiffened part.

19. The method according to claim 12, wherein the stiffened part furthermore comprising a second structure made from thermoset composite material, distinct from the first structure, the first structure is at least partly incorporated in the second structure and/or juxtaposed on a surface of the second structure.

20. The method according to claim 12, wherein the stiffened part is a satellite antenna reflector.
